(19) United States
(12) Patent Application Publication
(10) Pub. No.: US 2013/0299207 A1
(43) Pub. Date: Nov. 14, 2013

(54) POWER TOOL COOLING

(71) Applicant: Gabriel da Graca, Parkville, MD (US)

(72) Inventor: Gabriel da Graca, Parkville, MD (US)

(73) Assignee: BLACK & DECKER, INC., Newark, DE (US)

(21) Appl. No.: 13/468,959

(22) Filed: May 10, 2012

(51) Int. Cl. B25F 5/02; B25F 5/00

(52) U.S. Cl. 173/216; 173/217; 173/170; 173/171

(57) ABSTRACT

An electric power tool is provided. The electric power tool includes a motor housing having inlet and outlet slots and an electric motor received within the motor housing. The electric motor is configured to drive a working spindle. The electric power tool includes a ventilation device disposed within the motor housing and configured to generate an airflow between the inlet and outlet slots. The electric power tool also includes an airflow gear case attached to the motor housing. The airflow gear case having an opening to receive the working spindle and bearings. An airflow sleeve covers the airflow gear case, wherein at least a portion of the airflow received from the motor housing is introduced along an airflow path defined by the airflow gear case and the airflow sleeve.

### BACKGROUND

The subject matter disclosed herein relates generally to electric power tools. More particularly, the subject matter disclosed herein relates to, a mechanism for cooling a front end of such electric power tools. The disclosure also relates to a spindle lock for electric power tools.

A typical electric power tool, such as a rotary power tool, includes a housing, a motor supported by the housing and connected to a power source to operate the motor, and a working spindle rotatably supported by the housing and driven by the motor. A ventilation device, such as a fan, is also located in the housing. A tool holder is mounted on a front end of the tool and a tool element is supported by the tool holder for rotation with the spindle to operate on a workpiece.

During operation of the electric power tool, a user typically holds a handle at the rear motor housing end with one hand but sometimes may also hold the tool by the front end using another hand. However, the front end can get hot during operation of the power tool thereby making it uncomfortable for a user to hold and operate the tool. In certain situations, if the front end gets too hot, the user may have to stop working and wait for the front end to cool down.

When users need to place an accessory tool into the tool holder, they lock the spindle against rotation. Typically, electric power tools include a spindle lock for preventing rotation of the spindle when a force must be applied by the operator to the tool holder to remove/replace the tool element.

The spindle lock may be a manually operated spindle lock, in which the operator engages a lock member against the spindle to prevent rotation of the spindle. Some such locking mechanisms can be cumbersome, inconvenient and time consuming.

### DRAWINGS

FIG. 1 is an assembled perspective view of an electric power tool in accordance with one embodiment;

FIG. 2 is an exploded view illustrating components of the electric power tool of FIG. 1;

FIG. 3 illustrates a cross-sectional view of the electric power tool of FIG. 1 along with airflows through different portions of the electric power tool;

FIG. 4 illustrates an example configuration of the airflow gear case of FIG. 2 in accordance with an embodiment;

FIG. 5 illustrates an example configuration of the airflow sleeve of FIG. 2 in accordance with an embodiment;

FIG. 6 illustrates example simulation results for airflow profile for the electric power tool of FIG. 2;

FIG. 7 illustrates a partial perspective view of a gear case of an electric power tool with a spindle lock;

FIG. 8 is an end view showing a second end of the spindle lock engaged with the spindle in locked and unlocking position;

FIG. 9A illustrates an example configuration of the spindle lock of FIG. 7 in accordance with a first embodiment;

FIG. 9B illustrates another example configuration of the spindle lock of FIG. 7 in accordance with a second embodiment;

FIG. 10 illustrates an example configuration for an actuator for the spindle lock of FIG. 7;

FIG. 11 illustrates another example configuration for an actuator for the spindle lock of FIG. 7; and

FIG. 12 illustrates another example configuration for an actuator for the spindle lock of FIG. 7.

### DETAILED DESCRIPTION

Embodiments of the present disclosure function to provide a technique for cooling a front end or a handle end of an electric power tool such as a die grinder. An embodiment can utilize at least a portion of the airflow from a motor housing of the electric power tool to cool the handle end. Furthermore, embodiments provide a spindle lock for an electric power tool that is attached to a gear case of the electric power tool to lock the spindle against rotation about a longitudinal spindle axis of rotation.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

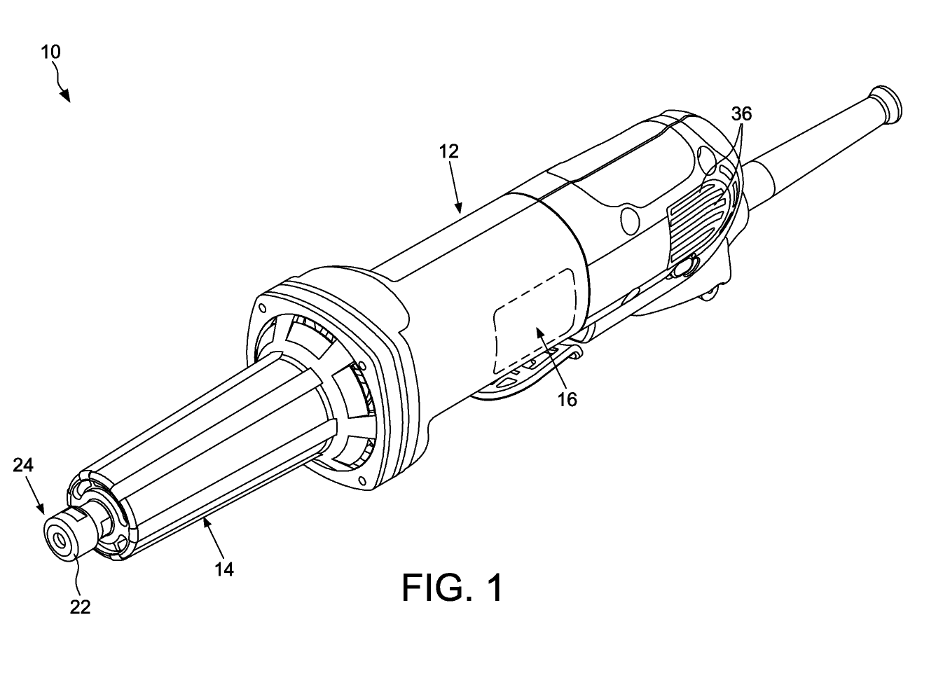

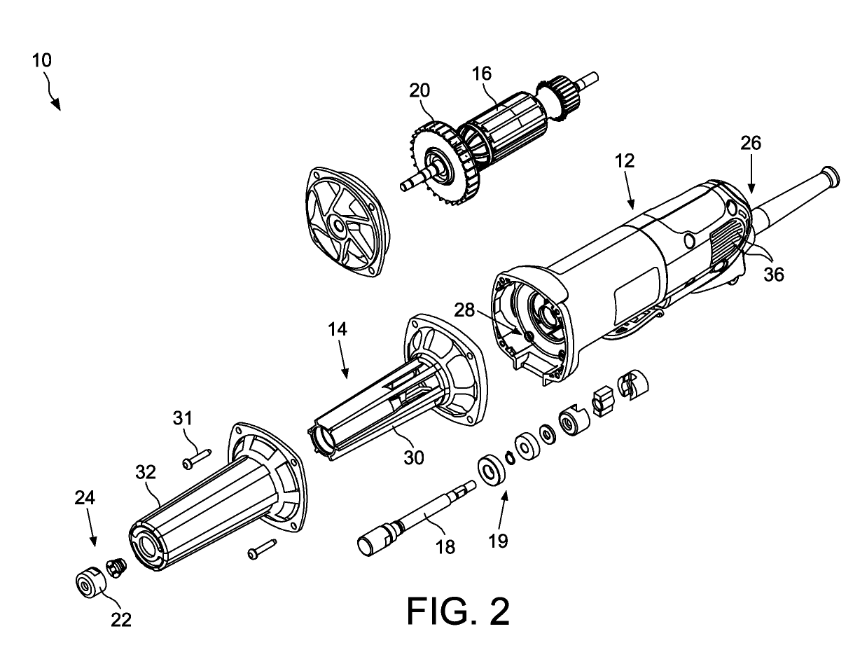

Referring to FIGS. 1 and 2, an electric power tool 10 is illustrated. The electric power tool 10 includes a motor housing 12 and a front end 14. Front end 14 may also be referred to as a handle end or a handle member. Motor housing 12 is cylindrical in shape and includes a motor 16, which can be of any suitable type. Motor 16 is configured to drive a working spindle 18, the motor being rotatably supported by motor housing 12. Motor housing 12 further includes a ventilation device such as a fan 20 to generate an airflow.

Referring to FIG. 2, an abrasive accessory (not shown) is mounted in a tool fitting 22 at an operating end 24 of front end 14. In the illustrated embodiment, electric power tool 10 is a die grinder. It should be understood that, in other constructions, electric power tool 10 could be of another type without departing from the scope of the present disclosure. Referring to FIG. 2, in an embodiment, motor housing 12 includes inlet slots 36 at a rear end 26 of the tool 10 and outlet slots generally represented by reference numeral 28. Front end 14 includes an airflow assembly attached to motor housing 12, which in turn, includes an airflow gear case 30 and an airflow sleeve 32 covering the airflow gear case 30. In this example embodiment, at least a portion of the airflow received from motor housing 12 is introduced along an airflow path within the airflow assembly (e.g., between gear case 30 and sleeve 32). Airflow gear case 30 is configured to receive working spindle 18 and bearings 19. In an embodiment, a portion of the airflow from motor housing 12 is introduced along an airflow path defined by and between airflow gear case 30 and airflow sleeve 32 resulting in cooling of front end 14.

Referring to FIG. 2, a number of horizontal slots 36 are provided on motor housing 12. These slots 36 are located behind motor 16 and may serve as motor air inlets or cooling air inlets. In one example embodiment, slots 36 are provided on each side of motor housing 12. In certain embodiments, additional slots may be provided adjacent motor 16. As will be appreciated by those skilled in the art, the components such as the airflow gear case 30 and airflow sleeve 32 are assembled using suitable coupling mechanisms such as screws 31. However, other coupling mechanisms like using an interference fit or an adhesive may be employed.

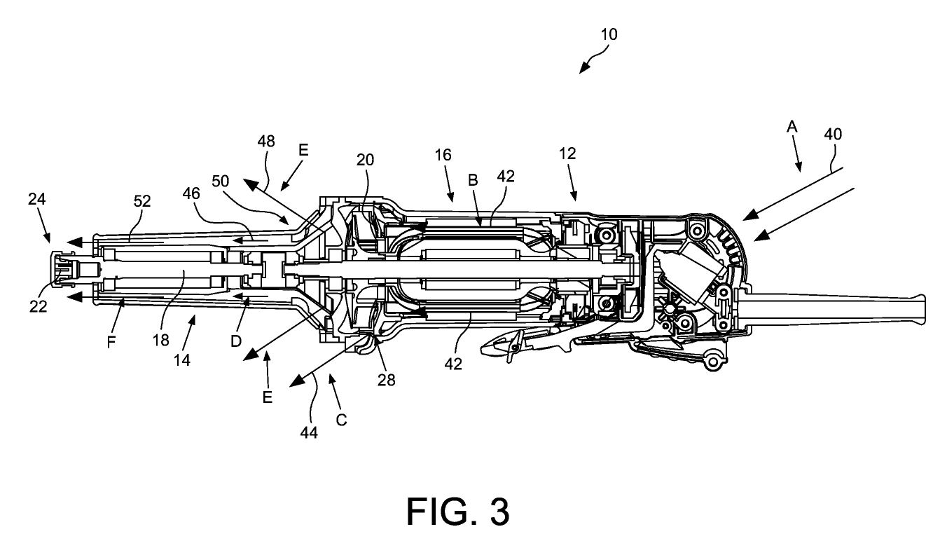

During operation of electric power tool 10, the rotation of ventilation device 20 produces an airflow for cooling motor 16. In an example embodiment, at least a portion of the airflow from motor housing 12 is introduced along the airflow path into front end 14 to facilitate cooling of front end 14, as will be described below with reference to FIG. 3.

FIG. 3 illustrates a cross-sectional view of electric power tool 10 of FIG. 1 along with airflows depicted by flow arrows through different portions of electric power tool 10. In the illustrated embodiment, intake airflow through slots 36 is represented by a first set of flow arrows (A) 40. The airflow represented by the first set of flow arrows 40 passes into motor housing 12 for cooling motor 16 and the sides of the housing 12. A second set of flow arrows (B) 42, depict the airflow passing through motor housing 12.

Referring again to FIG. 3, as the air flows from rear end 26 to operating end 24, it may separate into multiple airflow streams. In an example embodiment, a third set of airflow arrows (C) 44 show a first divided airflow stream and a fourth set of airflow arrows (D) 46 depict second divided airflow stream. In an embodiment, first airflow stream 44 is discharged through outlet slots 28 of motor housing 12.

Referring to FIG. 3, in another example embodiment, airflow from arrows (D) 46 is diminished by airflow (E) 48 discharged from vents near a first end 50 of front end 14. The rest of the (D) 46 airflow depicted by a sixth set of arrows (F) 52 passes through front end 14 to facilitate cooling of front end 14 and can be discharged near operating end 24 of electric power tool 10. While various air flow paths are described above as being associated with a particular embodiment, the invention contemplates any combination of these flow paths being associated together in a single embodiment.

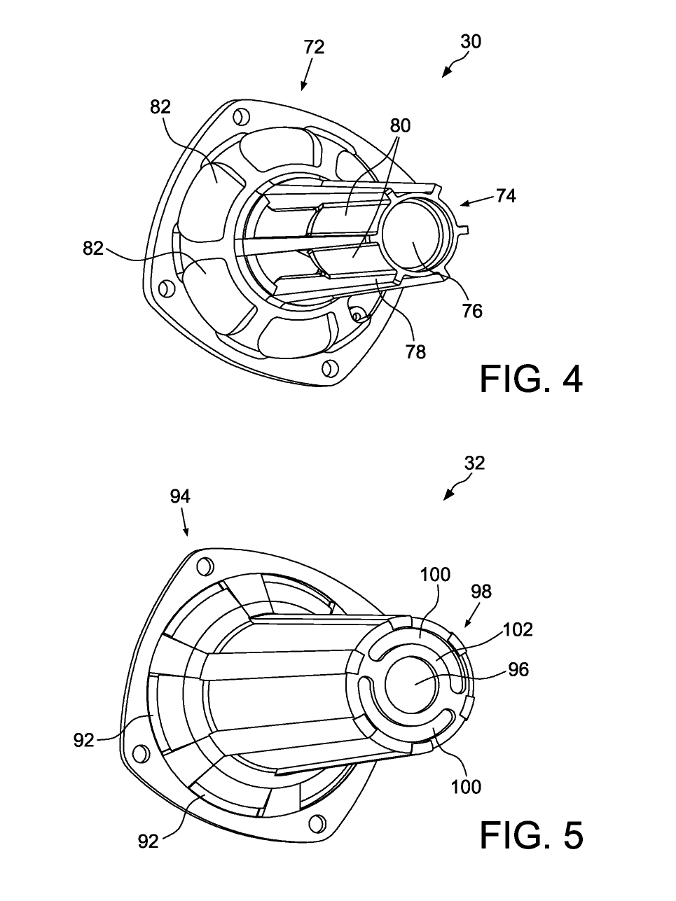

FIG. 4 illustrates an example configuration of airflow gear case 30 of FIG. 2. An inner end 72 of airflow gear case 30 is attached to motor housing 12 of electric power tool 10. An outer end 74 of airflow gear case 30 includes an opening 76 that is generally circular in shape. Working spindle 18 and the bearings 19 are received within opening 76 of airflow gear case 30.

In the illustrated embodiment, the airflow gear case 30 has a shape converging from inner end 72 to outer end 74 and includes a plurality of ribs 78 extending radially along the length of the airflow gear case 30 between the inner and outer ends 72 and 74. In this example embodiment, airflow gear case 30 is formed of aluminum. However, other suitable materials may be utilized for airflow gear case 30.

In this example embodiment, airflow gear case 30 includes six ribs. In one example embodiment, a length of each of ribs 78 is about 110 mm and a thickness of each of ribs 78 is in a range of about 2 mm to about 3 mm. However, the number, dimensions and the geometry of the ribs may vary depending upon the configuration of airflow gear case 30. Moreover, airflow gear case 30 includes generally planar surfaces 80 between ribs 78 extending at least partially along the length of airflow gear case 30. Also, the purpose of the ribs is in part to provide support for airflow sleeve 32.

In an example embodiment, airflow gear case 30 also includes a plurality of vents 82 on inner end 72 of airflow gear case 30. A portion of the airflow received from motor housing 12 may be discharged at inner end 72 via vents 82. In this example embodiment, airflow gear case 30 includes about six vents 82. However, the number and size of the vents may be customized depending upon a desired amount of flow to be discharged through vents 82. Moreover, in this embodiment, vents 92 have generally rectangular shape. Other shapes may be envisaged for vents 82. In alternate embodiments, inner end 72 may not include vents 82 and the entire airflow may be introduced into front end 14.

FIG. 5 illustrates an example configuration of the airflow sleeve 32 of FIG. 2. As illustrated, the shape of the airflow sleeve 32 is substantially the same as that of airflow gear case 30. Airflow sleeve 32 covers airflow gear case 30 to define the airflow path within which second airflow stream 46 (see FIG. 3) flows into front end 14. Airflow sleeve 32 may be attached to airflow gear case 30 using a suitable coupling mechanism such as through screws or a bolted coupling, or an interference fit, or a molded locking mechanism, or a snap-on type arrangement among others. In operation, at least a portion of the airflow from motor housing 12 flows in gaps between the airflow gear case 30 and airflow sleeve 32 adjacent to planar surface 80 to facilitate cooling of front end 14.

In the illustrated embodiment, airflow sleeve 32 includes a plurality of airflow vents 92 on a first end 94 of airflow sleeve 32. Airflow vents 92 correspond to respective vents 82 of airflow gear case 30 and are configured to discharge a portion of the airflow on the first end 94 of airflow sleeve 32. In this example embodiment, airflow sleeve 32 includes six airflow vents 92. However, based on parameters such as the configuration of airflow sleeve 32, a desired flow to be discharged through the vents, the number of airflow vents 92 may be lesser or greater. Moreover, in this example configuration, airflow vents 92 are generally rectangular in shape. As will be appreciated by those skilled in the art, airflow vents 92 may have alternative shapes such as oval, trapezoidal, polygonal, and circular shape, among others.

In this example embodiment, airflow vents 92 are configured to generate a generally conical airflow pattern directed towards operating end 24 of the electric power tool 10. It should be noted that parameters such as a number, a shape and an orientation of airflow vents 92 may be customized to control a volume of the airflow to generate the conical airflow stream. Advantageously, airflow vents 92 facilitate directing the conical airflow stream away from a user of electric power tool 10. Moreover, the conical airflow stream also facilitates directing any accumulated debris at operating end 24 of electric power tool 10 away from a user operating power tool 10.

In one example embodiment, airflow sleeve 32 may include a plurality of ribs (not shown) in addition to or in place of ribs 78 of airflow gear case 30. Also, the purpose of ribs 78 in part is to adequately support the front handle. Again, a number, shape and size of the ribs may vary based upon parameters such as size of airflow sleeve 32, a desired flow through airflow sleeve 32, strength requirements and so forth. The airflow received from motor housing 12 flows within and through gaps between the ribs to facilitate cooling of front end 14.

Airflow sleeve 32 includes an opening 96 located on a second end 98 of airflow sleeve 32 corresponding to opening 76 of airflow gear case 30. Moreover, airflow sleeve 32 includes at least one vent 100 on second end 98 for discharging airflow from front end 14. In an example embodiment, airflow sleeve 32 includes two generally semicircular or arcuate shaped vents 100 around opening 96. However, second end 98 may have a greater or lesser number of such vents 100. In addition, a variety of shapes may be envisaged for such vents 100. It should be noted that ring shaped features 102 on second end 98 also act as a bearing shield and facilitate prevention of flying debris from getting into bearings.

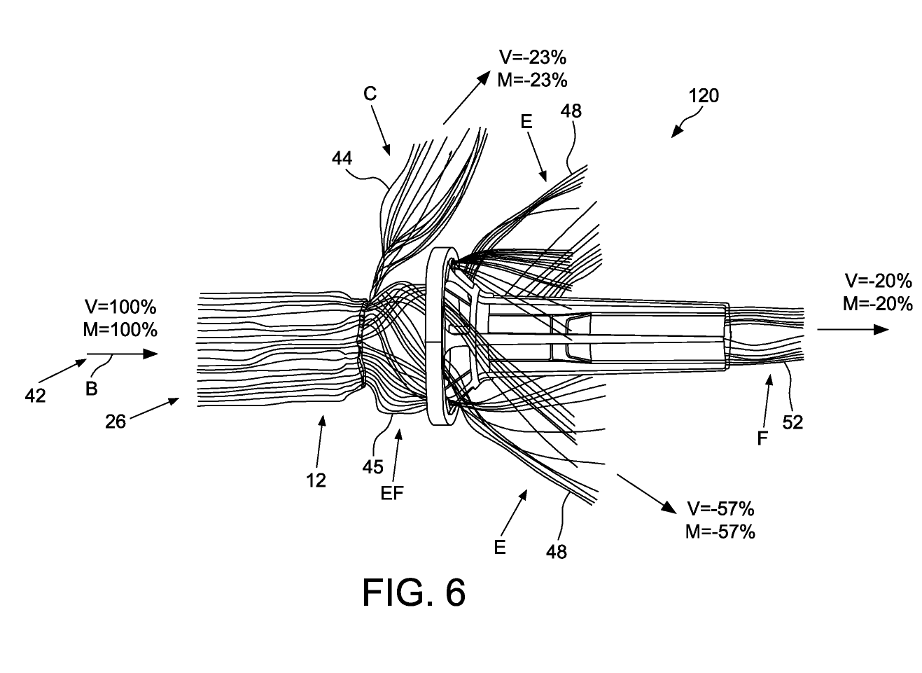

FIG. 6 illustrates example simulation results for a simulation test performed for the electric power tool described above. The airflow profile obtained from the simulation is depicted by reference numeral 120. In this example embodiment, inlet airflow 42 (represented by the set of arrows B) with volume and flow rates of about 100% flows through inlet slots 26 into electric power tool 10. Airflow 42 passes through motor housing 12 adjacent to motor 16 of electric power tool 10 and is separated into the first and second airflow streams generally represented by reference numerals 44 and 45 [represented by the set of arrows C and EF respectively]. First airflow stream 44 is discharged through outlet slots 28 of motor housing 12. In this example embodiment, the volume and mass flow rate of first airflow stream 44 discharged through outlet slots 28 is about 23%.

Second airflow stream 45 separates into two flow paths. A first path 52 represented by arrow F of airflow stream 45 is introduced into front end 14 of electric power tool 10. In this example embodiment, a portion 48 (represented by the set of arrows E) of the second airflow stream 45 is discharged through airflow vents 82 and 92 of the airflow gear case 30 and sleeve 32 respectively. In one example embodiment, the volume and the mass flow rate of airflow stream 48 is about 57%. Referring to FIGS. 1, 5 and 6, remaining portion 52 (represented by the set of arrows F) of second airflow stream 46 is introduced into front end 14 to facilitate cooling of front end 14 and is subsequently discharged through vents 100 located at second end 98 of airflow sleeve 32. In one example embodiment, the volume and mass flow rate of airflow stream 52 discharged through vents 100 is about 20%.

The foregoing airflow distribution percentages are non-limiting examples, other percentages could be used. In an example embodiment, airflow E is modified, so that the airflow stream F has an effective CFM that is strong enough to clear chips, but not so strong that it blows chips back into the users face.

In alternative embodiments, the air flow rate from the different airflow vents and second end 98 can be varied and adjusted per user requirements. For example, referring to FIGS. 4 and 6, in an alternative embodiment airflow sleeve 32 can be rotated (e.g., relative to gear case 30) to change the effective opening size of airflow vents 92 thereby modifying the airflow rate of stream E. Specifically, stream E air flow is maximized when vents 82 align with vents 92. In another example embodiment, stream E can be completely closed by closing off airflow vents 92, then 100% of the airflow can be discharged through the remaining streams C and F.

As will be appreciated by those skilled in the art, the volume and mass flow rates provided for the different airflow streams above may vary based upon a variety of parameters such as the design of airflow gear case 30 and airflow sleeve 32 of electric power tool 10, a desired amount of flow through front end 14 and so forth. Moreover, the airflow profile may also vary based upon such parameters. For example, in certain embodiments, the entire airflow 42 from motor housing 12 may be introduced through front end 14 and no airflow may be discharged through outlet slots 28 of motor housing 12 and airflow vents 92. A variety of such airflow profiles may be envisaged based upon the configuration of electric power tool 10.

In the illustrated embodiment, second airflow stream 46 discharged through airflow vents 92 forms a conical airflow stream that is directed towards operating end 24 of electric power tool 10. Advantageously, this directs the flow away from the user of electric power tool 10 and also facilitates directing any accumulated debris away from the user.

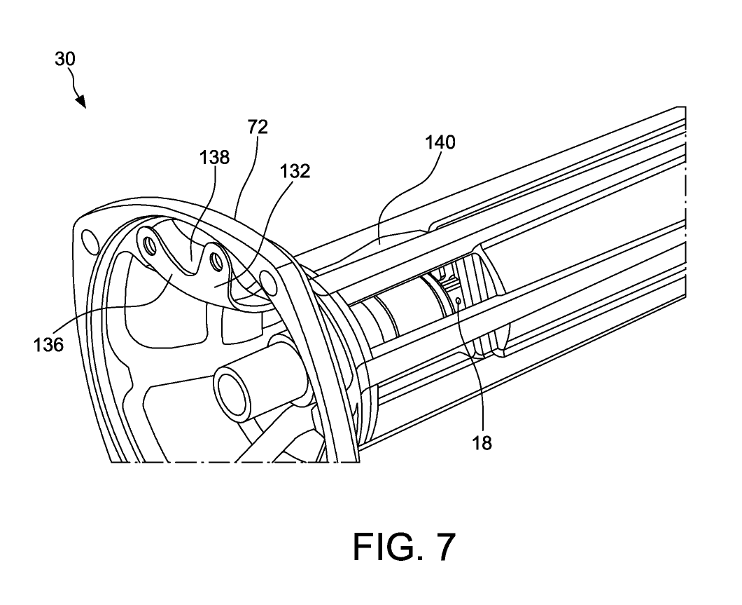

FIG. 7 illustrates a partial perspective view of gear case 30 of electric power tool 10 with a spindle lock 132. As previously described, the electric power tool 10 includes spindle 18 driven by an electric motor 16. Spindle 18 is mounted within a gear case 30 for rotation about a longitudinal rotational axis. Spindle lock 132 is configured to lock spindle 18 against rotation about the rotational axis. In an embodiment, spindle lock 132 selectively locks spindle 18 against rotation to attach and/or remove an accessory to/from spindle 18. In the illustrated embodiment, a first end 136 of spindle lock 132 is engaged with corresponding walls 138 of gear case 30 and a second end 140 of spindle lock 132 is engageable with the spindle 18.

In this embodiment, an actuator (not shown) is accessible from the top surface of sleeve 32 (not shown in FIG. 7) covering gear case 30 and operatively engages spindle lock 132. In one embodiment, the actuator includes a radial push-down button. In an alternate embodiment, the actuator includes an axial sliding mechanism. The actuator is utilized to facilitate the locking of spindle 18 by urging spindle lock 132 into an interlocking engagement with spindle 18. The actuator can be located on a back surface of the sleeve so that it is not accidently operated by a user of electric power tool 10. A user can conveniently lock spindle 18 against rotation by urging the actuator, which in turn, engages spindle lock 132 with the spindle 18 in an interlocking position. In another embodiment, the actuator can be a rotational actuation mechanism, such as a rotational cam. In example embodiments, springs can be added, but are not necessary, to the actuators to bias them to an unlocked position as spindle lock 132 may be a resilient member.

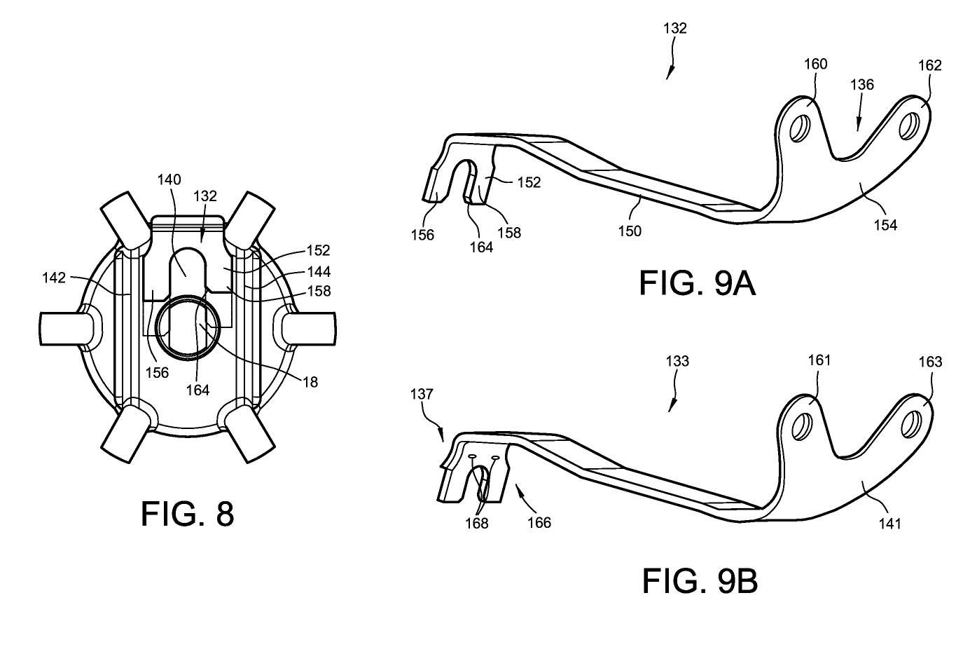

FIG. 8 is a cross-sectional end view showing second end 140 of spindle lock 132 engaged with spindle 18 in the dashed line configuration. Second end 140 is disengaged as showed in the solid line configuration. As can be seen, gear case 30 includes first and second lateral supports 142 and 144 in adjacent outer positions relative to second end 140 in the locked configuration. Lateral supports 142 and 144 are configured to absorb any torsional pressure on second end 140. It should be noted that gear case 30 may include a greater or lesser number of such supports. As can be seen, second end 140 includes two prongs arranged in a U-shaped configuration that will be described below with reference to FIG. 9.

FIG. 9A illustrates an example configuration of spindle lock 132 of FIG. 7. As illustrated, spindle lock 132 is an elongated flexible member having a middle member 150 located between first end 136 and second end 140. Second end 140 of spindle lock 132 further includes a two pronged lock member 152. Lock member 152 includes a first prong 156 and a second prong 158. First prong 156 is simultaneously engageable with spindle 18 and lateral support 144 and second prong 158 is simultaneously engageable with spindle 18 and lateral support 142. During operation, first end 136 of spindle lock 132 is attached to first end 72 of gear case 30 and lock member 152 engages spindle 18. In this example embodiment, lateral support walls 142, 144 that are formed on gear case 30 cooperate with first and second prongs 156, 158 such that in a locking configuration/mode (dashed lines in FIG. 8), the walls can correspondingly engage the prongs to provide support to prevent continued rotation of spindle 18. Locking member thereby effectively transfers the stopping stress from spindle 18 to the walls and the walls stop spindle 18 from further rotation.

In another embodiment, spindle lock 133 is a spring member removeably attached to connection end 137 which engages spindle 18 and lateral supports 142 and 144. In this embodiment, the spring is attachable to a separate locking member 166, which in-turn engages spindle 18 that will be described in a greater detail below.

In this example embodiment, locking member 152 includes two prongs 156 and 158 arranged in a U-shape configuration. Similarly, connecting member 154 includes two prongs 160 and 162 arranged in a U-shaped configuration, this connecting member could be designed in any configuration that can be attached to gear case 30 and is not limited to a u-shaped configuration.

In an embodiment, the length of the prong 156 is greater than the length of the prong 158. The differing lengths prevent unintentional locking of spindle 18, as described below. In operation, when power tool 10 is running, engagement of prong 156 with spindle 18, creates a vibration and corresponding buzzing sound that alerts the user if they have unintentionally triggered spindle lock 132. If the tool is not running, prongs 156, 158 engage with spindle 18 (as shown in dashed lines in FIG. 8) to lock the spindle 18 against rotation. Thus, a user can conveniently lock spindle 18 against rotation by pressing the actuator, which in turn, engages spindle lock 132 with spindle 18.

As will be appreciated by one skilled in the art, the parameters such as shapes and size of locking member 152 and connecting member 154 may be varied based on desired operating conditions. FIG. 9B illustrates another example embodiment 133 of spindle lock 18. In the illustrated embodiment, spindle lock 133 includes a first connecting end 137 and a connecting member 141. As with the embodiment of FIG. 9A, the connecting member 141 includes two prongs 161 and 163 arranged in a U-shaped configuration. However, other shapes may be envisaged. Moreover, an additional metal portion 166 may be attached to connecting end 137 of spindle lock 133. In this example embodiment, the additional metal piece 166 is attached to connecting end 137 using bolted coupling 168. A bolted coupling is a non-limiting example of securing means, screws, rivets, press fit, adhesive or any other securing method could be used. The additional metal portion 166 can provide added thickness to spindle lock 132 at locking end 137. The additional metal portion 166 may be of any desired shape and size to provided the required thickness to the spindle lock. As will be appreciated by one skilled in the art, a variety of other configurations may be envisaged.

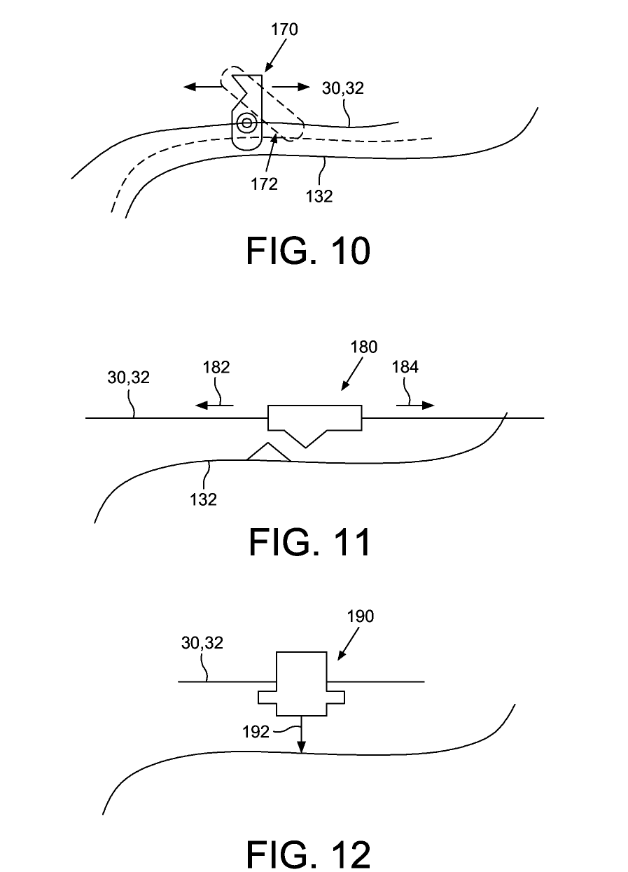

FIGS. 10-12 illustrate example actuation mechanisms for operatively engaging spindle lock 132 with spindle 18 of power tool 10 by moving lock member 152, 137 radially into contact with spindle 18. In the embodiment illustrated in FIG. 10, the actuator includes a rotational cam 170 positioned on gear case 30 or sleeve 32 in a locked position. Moreover, an unlocked configuration 172 is illustrated by dashed lines. In the embodiment illustrated in FIG. 11, the actuator includes an axial sliding mechanism 180 located on a top surface of the gear case 30 or sleeve 32. An axial sliding mechanism 180 allows the user to slide into locking and release positions generally represented by reference numerals 182 and 184 respectively thereby facilitating the locking and release of spindle lock 132. A ramp on each of the actuator and spindle lock 132 engage each other to force spindle lock 132 radially inward toward the spindle rotational axis to engage spindle 18.

In the embodiment, illustrated in FIG. 12, the actuator includes a radial push-down button 190. A user may push the button 190 in a radial direction 192 into engagement with spindle lock 132. Further depression of the button depresses spindle lock 132 which in turn urges lock member 152 into a locked configureation as shown in dashed lines in FIG. 8 to facilitate the locking of the spindle 18. Referring to FIG. 1, in certain example embodiments, the actuator can be located generally where the front end is connected to the motor housing.

The various aspects of the structures described hereinabove may be used in electric power tools such as a die grinder, among others. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electric power tool, comprising:
a motor housing having inlet and outlet slots;
an electric motor received within the motor housing, the electric motor configured to drive a working spindle;
a ventilation device disposed within the motor housing and configured to generate an airflow between the inlet and outlet slots; and
an airflow assembly attached to the motor housing, wherein at least a portion of the airflow received from the motor housing is introduced along an airflow path within the airflow assembly.

2. The electric power tool of claim 1, wherein the airflow assembly further comprises:
an airflow gear case attached to the motor housing, the airflow gear case having an opening to receive the working spindle and bearings; and
an airflow sleeve covering the airflow gear case, wherein the airflow path is defined between the airflow gear case and the airflow sleeve.

3. The electric power tool of claim 2, wherein the airflow gear case is configured to separate the airflow into first and second airflow streams, wherein the first airflow stream is discharged through the outlet slots of the motor housing and the second airflow stream is introduced along the airflow path.

4. The electric power tool of claim 2, wherein the airflow introduced within the airflow gear case facilitates cooling of the airflow gear case.

5. The electric power tool of claim 2, wherein the airflow introduced within the airflow gear case removes debris at a working end of the electric power tool.

6. The electric power tool of claim 2, wherein the airflow sleeve comprises a plurality of airflow vents on a first end of the airflow sleeve, wherein the airflow vents discharge a portion of the airflow.

7. The electric power tool of claim 6, wherein the airflow vents are configured to generate a conical airflow directed towards an operating end of the tool.

8. The electric power tool of claim 6, wherein the airflow sleeve is configured to be rotatable about an axis to adjust an effective size of the airflow vents.

9. The electric power tool of claim 2, wherein at least one of the airflow gear case and the airflow sleeve comprises a plurality of ribs extending along the length of the respective airflow gear case and the airflow sleeve, wherein the airflow flows within gaps between the ribs.

10. The electric power tool of claim 2, wherein the airflow sleeve comprises at least one vent located around the opening of the airflow gear case for discharging the second airflow stream.

11. A handle member for an electric power tool, the handle member comprising:
an airflow gear case configured to receive an airflow from a ventilation device of the electric power tool, wherein the airflow gear case comprises an opening to receive a working spindle and bearings of the electric power tool; and
an airflow sleeve covering the airflow gear case, wherein gaps between the airflow gear case and the airflow sleeve define an airflow path for introducing at least a portion of the received airflow within the handle member.

12. The handle member of claim 11, wherein the airflow sleeve covering the opening comprises at least one vent located around the opening for discharging the airflow stream.

13. The handle member of claim 11, further comprising a plurality of airflow vents to generate a conical airflow stream, wherein the conical airflow stream is discharged towards a gear case end of the electric power tool.

14. A spindle lock for an electric power tool, the electric power tool comprising an electric motor mounted within a motor housing and a spindle mounted within a gear case for rotation about an axis, the spindle driven by the electric motor, the spindle lock comprising:
an elongated flexible member having a middle member located between first and second connecting members, wherein the first connecting member is engaged with a corresponding surface of the gear case and the second connecting member is engaged with a corresponding surface of the spindle to lock the spindle against rotation about the axis.

15. The spindle lock of claim 14, wherein the spindle lock further comprises an actuator to engage the first and second connecting members in a locking position.

16. The spindle lock of claim 14, wherein each of the first and second connecting members comprises two prongs arranged in a U-shape configuration.

17. The spindle lock of claim 16, wherein a length of a first prong of the second connecting member is greater than a length of a second prong of the second connecting member.

18. The spindle lock of claim 17, wherein the first prong engages with the spindle upon activation of the actuation mechanism and subsequently the second prong engages with the spindle to lock the spindle against rotation.

19. The spindle lock of claim 18, wherein an engaging surface of the first prong is chamfered.

20. The spindle lock of claim 14, wherein the second connecting member engages with corresponding walls of the gear case to prevent rotation of the spindle in a locking position.
